(19) United States
(12) Patent Application Publication
(10) Pub. No.: US 2016/0153443 A1
(43) Pub. Date: Jun. 2, 2016

(54) SENSOR ASSEMBLY FOR MEASURING DYNAMIC PRESSURE IN RECIPROCATING PUMPS

(71) Applicant: LIME INSTRUMENTS, LLC, Houston, TX (US)

(72) Inventor: Cory Glass, Houston, TX (US)

(73) Assignee: LIME INSTRUMENTS, LLC, Houston, TX (US)

(21) Appl. No.: 14/528,705

(22) Filed: Oct. 30, 2014

Related U.S. Application Data
(60) Provisional application No. 61/897,781, filed on Oct. 30, 2013.

(51) Int. Cl. F04B 51/00; G01L 23/26; F04B 27/08; F04B 53/10; F04B 1/16; F04B 1/12

(52) U.S. Cl. CPC F04B 51/00; F04B 1/16; F04B 1/128; F04B 1/124; F04B 27/0878; F04B 27/0891; F04B 27/0895; F04B 53/10; G01L 23/26

(57) ABSTRACT

The present invention describes a reciprocating pump containing a pressure sensor assembly including a monitor, a computer, and a pressure sensor in electrical communication with the monitor to sense a pressure value of a fluid within the chamber of a pump cylinder.

### CROSS REFERENCE TO RELATED APPLICATION

This application claims benefit under 35 U.S.C. §119(e) to U.S. Provisional Application No. 61/897,781, filed Oct. 30, 2013, which is incorporated by reference herein in its entirety.

### BACKGROUND OF THE INVENTION

1. Field of the Invention

The present invention relates generally to reciprocating pumps, more specifically to an assembly and method for monitoring operating conditions of the reciprocating pump.

2. Background Information

In oil field operations, reciprocating pumps are often used for various purposes. Some reciprocating pumps, generally known as “service pumps,” are typically used for operations such cementing, acidizing, or fracking the well. Usually, these service pumps run for relatively short periods of time but on a frequent basis. Often they are mounted to a truck or a skid for transport to various well sites. A pump might operate several times a week. Many times, several pumps will be connected in parallel to a flow line. The operator will know the output pressure of the group of pumps due to a pressure gauge on the flow line, but may not know the individual pump output pressure. The operator will often not know the pressure above the pistons, where a poorly performing pump might lead to damage of the device due to cavitation.

Cavitation is, in most cases, an undesirable occurrence. In devices such as pumps, cavitation causes a great deal of noise, damage to components, vibrations, and a loss of efficiency. When the cavitation bubbles collapse, they force energetic liquid into very small volumes, thereby creating spots of high temperature and emitting shock waves, the latter of which are a source of noise.

Although the collapse of a cavity is a relatively low-energy event, highly localized collapses can erode metals, such as steel, over time. The pitting caused by the collapse of cavities produces great wear on components and can dramatically shorten a pump's lifetime.

After a surface is initially affected by cavitation, it tends to erode at an accelerating pace. The cavitation pits increase the turbulence of the fluid flow and create crevices that act as nucleation sites for additional cavitation bubbles. The pits also increase the components' surface area and leave behind residual stresses. This makes the surface more prone to stress corrosion.

To periodically monitor the performance of a pump, an operator typically calls on the services of testing companies that will set up temporary sensors and monitor the performance of the pump during a test period. Generally, the testing service connects pressure gauges to the overall intake and discharge, as well as each individual pressure chamber. The testing service might also monitor the rotational speed and vibration. Then the testing service removes the test equipment and the pump continues operations without monitoring equipment.

Continuous monitoring of the pump through testing companies is not practical. Moreover, during operations, the pressure of the fluid inside of the pump can become quite high which makes it difficult to obtain readings of pressures within the pump at certain locations without leakage. Operators typically will not often use the testing equipment due to the cost associated with the testing companies. An operator may not have a pump tested unless something appears to be wrong with it. Accordingly, operators are often left in the situation of not knowing what the performance conditions of a pump are for long periods of time.

### SUMMARY OF THE INVENTION

The present invention relates to a system for monitoring reciprocating pump conditions, including the use of ballistic pressure sensors or transducers in electrical communication with a computer memory to sense dynamic pressure values of a fluid within the pump.

In embodiments, a reciprocating pump is disclosed including a pump housing that houses a crankshaft; a piston mechanically connected to the crankshaft for pumping a fluid through a cylinder, where the cylinder includes a fluid inlet and a fluid outlet; a monitor; a computer in transmission communication with the monitor, where the computer comprises a memory; and a ballistic pressure sensor mounted to the pump, where the ballistic sensor is in electrical communication with the monitor to sense a pressure value of a fluid within the pump.

In one aspect, the ballistic sensor is configured to engage within a cavity of a plug member or bolt, where the plug member or bolt partially extends into a portion of a cover plate mounted to the reciprocating pump, and where the bottom of the plug member or bolt is positioned adjacent to a chamber above the piston. In a related aspect, the plug member or bolt includes a non-conductive metal. In a further related aspect, the plug member or bolt includes anodized aluminum.

In another aspect, the ballistic sensor engages within the cavity of the plug member such that the diaphragm containing end of the ballistic sensor is flush mounted to a bottom surface of the plug member or bolt cavity or is flush fitted to a bore hole in the bottom of the plug member or bolt.

In embodiments, a reciprocating pump is disclosed including a pump housing that houses a crankshaft a plurality of pistons mechanically connected to the crankshaft for pumping a fluid through a plurality of cylinders, where the plurality cylinders include a fluid inlet and a fluid outlet, and where each of the piston rods comprise a piston portion on the end extending away from the crankshaft; a plurality of piston chambers in fluid communication with the piston portion of each of the piston rods, where each of the piston chambers receives fluid to be pumped by the piston portion of each of the piston rods, and where each of the piston chambers comprise a fluid inlet and a fluid outlet; a plurality of cover plates extending through a selected plurality of sidewalls of the reciprocating pump, where each of the cover plates comprises a threaded counter-bore, defining an outward facing shoulder; a monitor; a computer in transmission communication with the monitor, where the computer comprises a memory; and a plurality of ballistic pressure sensors mounted to the cover plates, where the plurality of ballistic sensors are in electrical communication with the monitor to sense a pressure value of a fluid within the pump.

In one aspect, the pump further includes a threaded plug member or bolt extending partially through each of the cover plates, the plug member or bolt having a cavity therethrough, which plug member or bolt registers with the cover plates within the counter-bore, where each of the ballistic sensors is flush mounted at the diaphragm containing end at an inward facing end of the plug member or bolt cavity or the diaphragm containing end is flush fitted into a bore hole at the bottom of the plug member or bolt, where the outward facing shoulder of the plug member or bolt is flush mounted to the inward facing end of the counter-bore, and where a delimited gap is formed between the outward facing end of the counter-bore and the outward facing end of the shoulder of the cover plate, which cover plate shoulder is proximal to the piston chamber, where the gap may optionally comprise a membrane behind which a fluid or a mechanical means communicates dynamic pressure through the cover plate to the sensor, thereby isolating the sensor from the fluid or the diaphragm containing end is directly contacting the fluid.

In another aspect, the pump further includes a memory housing, where the memory is a portable module that is adapted to be removed to have information retrieved from the memory at another location and replaced with another portable module to receive data from the sensors.

In embodiments, a method of monitoring the operating conditions of a reciprocating pump is disclosed including providing a computer with a memory, mounting the computer in a monitoring housing, and mounting the monitoring housing to the reciprocating pump; positioning a plurality of pressure sensor assemblies in impulse communication with ports formed in a selected location and electrically connecting the sensor assemblies to the computer of the reciprocating pump, operating the pump, sensing fluid pressure with the sensor assemblies; and communicating pressure values from each of the sensor assemblies to the memory. In some aspects, the computer may automatically shut down the pump or alter the pump performance if the sensor detects cavitation to prevent damage.

In one embodiment, a sensor assembly for sensing fluid pressure within a reciprocating pump cylinder is disclosed including a ballistic pressure sensor or transducer capable of measuring pressure within the cylinder; a bolt having a throughbore configured to hold the sensor or transducer; and a cover plate proximate to the cylinder configured to hold the bolt and sensor or transducer in a select position relative to the cylinder, where the ballistic pressure sensor or transducer is configured to generate an electric signal which is proportional to a pressure value within the cylinder of the pump.

In one aspect, the head of the bolt includes one or more tapped holes and a first projection at the top of the bolt, a second projection at the bottom of the bolt, or a combination thereof. In a related aspect, the first projection includes one or more recesses for engaging one or more prongs of a coaxial connector. In another related aspect, the first projection further includes one or more electrical leads which are in communication with the one or more recesses.

In another aspect, the bolt includes one or more tapped holes, a first projection on the top of the bolt, and a second projection at the bottom of the bolt. In a related aspect, the second projection is configured to mechanically transfer motions outside of the bolt to a diaphragm on the ballistic pressure sensor or transducer.

### BRIEF DESCRIPTION OF THE DRAWINGS

FIG. 1A shows separate views of the ballistic pressure sensor and bolt.

FIG. 1B shows the ballistic pressure sensor as seated within bolt cavity in one embodiment.

FIG. 2 shows separate perspective views of the ballistic pressure sensor (electronics containing side forward) and the bolt.

FIG. 3 shows the ballistic pressure sensor integrated with the bolt in another embodiment.

FIG. 4 shows a sectional view of the pump with the sensor coupled to a monitor.

FIG. 5 shows an enlarged sectional view of the sensor-bolt-cover plate assembly illustrating how the sensor may be coupled to a monitor.

FIG. 6 shows an enlarged sectional view of an alternative sensor-bolt-cover plate assembly illustrating how the sensor may be coupled to a monitor

FIG. 6A shows an enlarged view of a first alternative sensor-chamber fluid engagement assembly.

FIG. 6B shows an enlarged view of a second alternative sensor-chamber fluid engagement assembly.

FIG. 7 shows a frontal view of the sensor-bolt-cover plate assembly with the sensor coupled to a monitor.

FIG. 8 shows a sectional view of the pump with the sensor coupled to an in-line charge amplifier and a current source power unit.

FIG. 9 shows a frontal view of the sensor-bolt-cover plate assembly coupled to an in-line charge amplifier and a current source power unit.

FIG. 10 shows a sectional view of the pump with the sensor coupled to a current source power unit.

FIG. 11 shows a frontal view of the sensor-bolt-cover plate assembly coupled to a current source power unit.

FIG. 12A shows a side view of an alternate bolt configuration.

FIG. 12B shows a perspective view of the bolt of FIG. 12A.

FIG. 12C shows the top view of the bolt of FIG. 12A.

FIG. 12D shows the bottom view of the bolt of FIG. 12A.

FIG. 13A shows a side view of an alternate bolt configuration.

FIG. 13B shows a perspective view of the bolt of FIG. 13A.

FIG. 13C shows the bottom view of the bolt of FIG. 13A.

FIG. 13D shows an alternate perspective view of the bolt of FIG. 13A.

### DETAILED DESCRIPTION OF THE INVENTION

Before the present devices, methods, and methodologies are described, it is to be understood that this invention is not limited to particular devices, methods, and conditions described, as such devices, methods, and conditions may vary. It is also to be understood that the terminology used herein is for purposes of describing particular embodiments only, and is not intended to be limiting, since the scope of the present invention will be limited only in the appended claims.

As used in this specification and the appended claims, the singular forms “a”, “an”, and “the” include plural references unless the context clearly dictates otherwise. Thus, for example, references to “a piston” includes one or more pistons, and/or devices of the type described herein which will become apparent to those persons skilled in the art upon reading this disclosure and so forth.

Unless defined otherwise, all technical and scientific terms used herein have the same meaning as commonly understood by one of ordinary skill in the art to which this invention belongs. Any methods and materials similar or equivalent to those described herein can be used in the practice or testing of the invention, as it will be understood that modifications and variations are encompassed within the spirit and scope of the instant disclosure.

As used herein, “about,” “approximately,” “substantially” and “significantly” will be understood by a person of ordinary skill in the art and will vary in some extent depending on the context in which they are used. If there are uses of the term which are not clear to persons of ordinary skill in the art given the context in which it is used, “about” and “approximately” will mean plus or minus <10% of particular term and “substantially” and “significantly” will mean plus or minus >10% of the particular term.

As used herein, “consisting essentially of” means, the particular component(s) and may include other components, which other components do not change the novel properties or aspects of the particular component(s).

As used herein, “impulse communication” means transmission of the shock waves or thermal shock produced by a change in force (e.g., transmission of heat and/or shock waves due to dynamic changes in pressure in a chamber above a piston). “Plug member” and “bolt” are used interchangeably.

As used herein “ballistic sensor” or “sensor” refers to a measuring transducer that converts mechanical stress into an electrical signal, its operation is based on the piezoelectric effect. For example, under the action of a pressure being measured, electric charges appear on the external and internal sides of a pair of plates made of a piezoelectric material (e.g., quartz). By subjecting the material to mechanical stress (e.g., pressure), an electrical potential (i.e., voltage) is created across the sides of said material. If the two faces of the plates are connected together to make a circuit, current flows, and this current is used to indirectly measure said pressure.

In embodiments, the sensor may be flush mounted in a cover plate or wall. Flush mounting may be desirable for minimizing turbulence, avoiding a cavity effect or avoiding an increase in chamber volume. In other embodiments, the sensor may be recess mounted in a cover plate or wall. Recess mounting may be desirable in applications where the diaphragm end of the sensor is likely to be subjected to excessive flash temperatures or particle impingement.

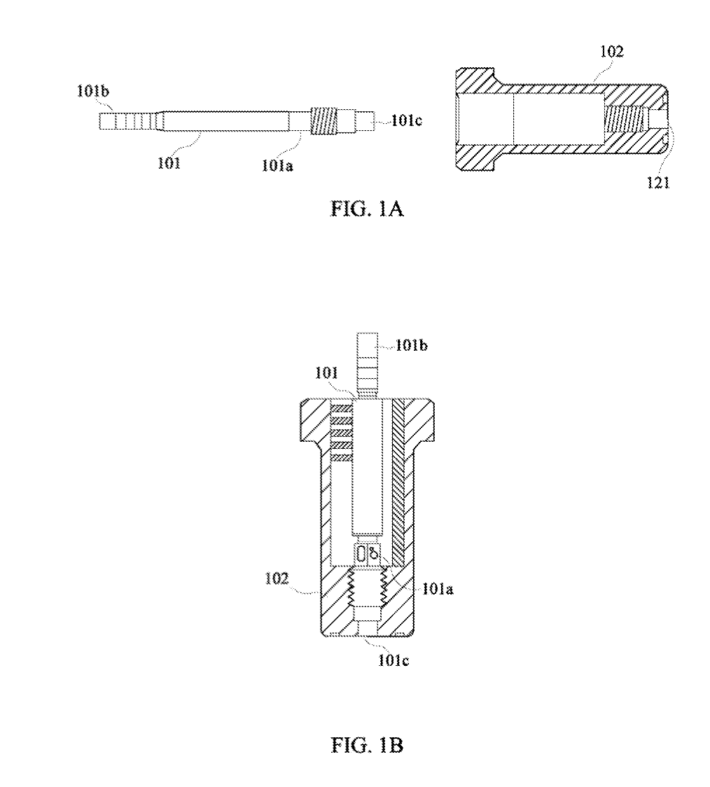

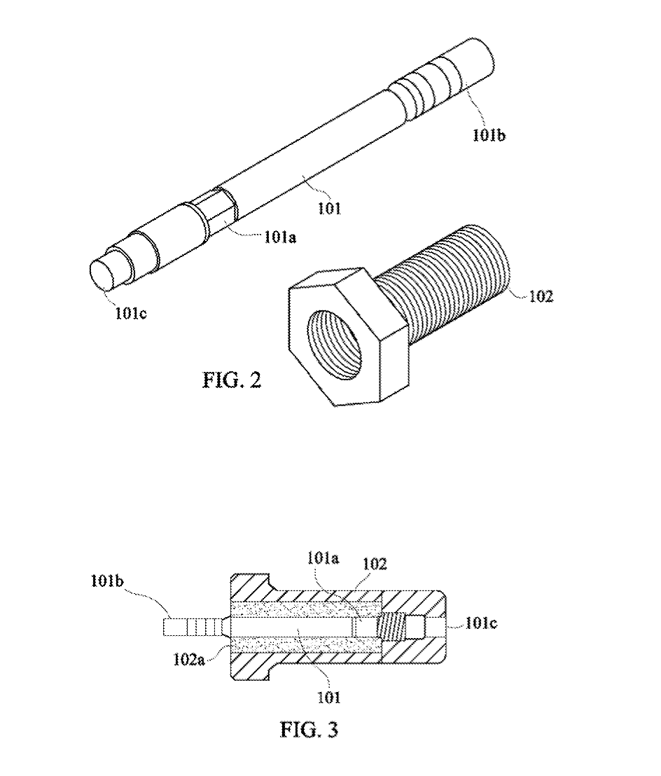

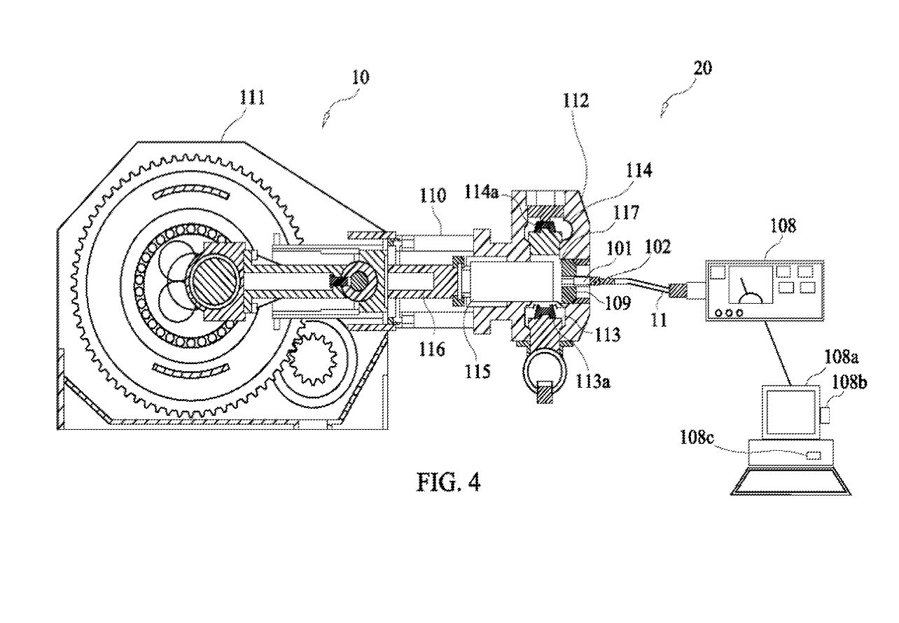

Referring to FIGS. 1-4, the sensor 101 and bolt 102 allow for measuring of dynamic pressure changes in the pump chamber 110 above the piston 115 of the pump assembly 10 via the diaphragm end 101c of the sensor. In one aspect, diaphragm 101e may be modified to better match one or more surfaces in the pump chamber 110 and/or other cavities in the pump 10.

In embodiments, the sensor 101 is a ballistic pressure sensor or transducer that is configured to generate an electric signal which is proportional to a pressure value within the chamber of the pump. Such sensors are commercially available from PCB Piezotronics, Inc. (Depew, N.Y.). Piezoelectric Pressure Sensors measure dynamic pressures, and are generally not suited for static pressure measurements. In embodiments, charge mode pressure sensors, which generate a high-impedance charge output, such as ICP?=(Integrated Circuit Piezoelectric) voltage mode-type sensors feature built-in microelectronic amplifiers that convert the high-impedance charge into a low-impedance voltage output, may be used. The bolt 102 may be made from a non-conductive metal (e.g., but not limited to, anodized aluminum). In embodiments, the pressure sensor 101 may be screwed into bolt 102. In another embodiment, pressure sensor 101 may be integral with bolt 102, where sensor 101 is seated within material 102a integrated in bolt 102 such that substantially only connector 101b is exposed (e.g., to stabilize the sensor). The diaphragm 101c may be exposed to a fluid through a hole 121 in the end of the bolt 102.

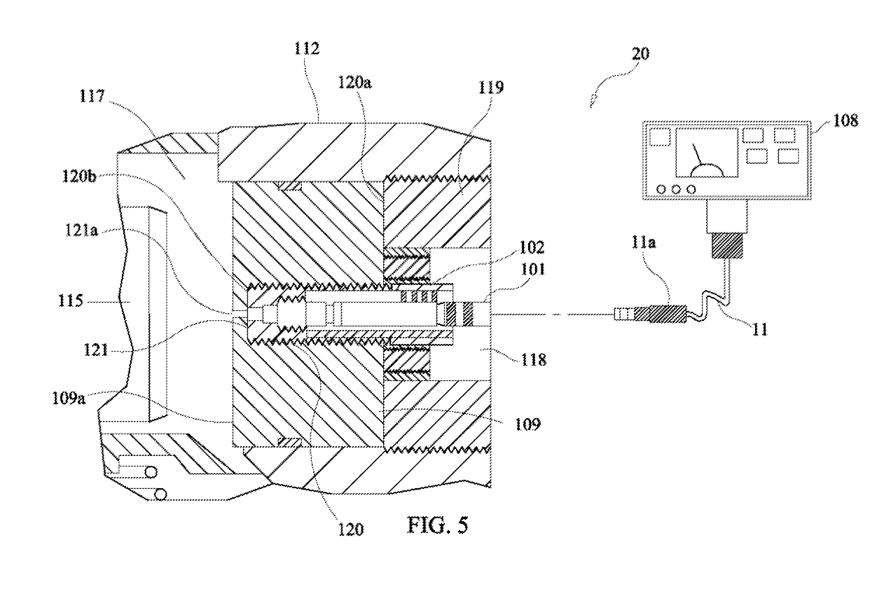

Referring to FIGS. 4-11, the reciprocating pump or pump 10 includes a sensor assembly 20 which includes a sensor 101, and bolt 102, a high insulation, low-noise cable 11, monitor 108, and computer 108a. The bolt 102 houses the sensor 101 within cover plate 109. A plunger or piston rod housing 110 attaches to a side of crankshaft housing 111 and extends into cylinder 112. Each cylinder 112 may include fluid inlet 113 and fluid outlet 114 (FIG. 4). As show in FIG. 4, cover plate 109 connects to an end of each cylinder 112 opposite from piston rod housing 110. While pump 10 is shown as a free standing device, pump assembly 10 may easily be mounted to a trailer that may be towed between operation sites, or to a skid such as for offshore operations.

A piston 115 connects to piston rod 116 for pumping the fluid passing through the reciprocating pump. Cylinder 112 connects to the end of piston rod housing 110 extending away from crankshaft housing 111 (FIG. 4). Cylinder 112 typically includes cylinder chamber 117, which is where the fluid being pumped by reciprocating pump 10 is compressed by piston 115. Cylinder 112 may include inlet valve 113a and outlet valve 114a, and may be spring loaded valves, which are actuated by a predetermined differential pressure. While spring loaded valves are described, the skilled artisan will understand that other valve opening and closing mechanisms may also be used, such as electronically controlled valves, rotary valves, cam actuated valves, and the like.

As piston 115 moves longitudinally away from cylinder chamber 117, the pressure of the fluid inside chamber 117 decreases creating a differential pressure across inlet valve 113a, which actuates valve 13a and allows the fluid to enter cylinder chamber 117 from fluid inlet 113. The fluid being pumped enters cylinder chamber 117 as piston 115 continues to move longitudinally away from cylinder 112 until the pressure difference between the fluid inside chamber 117 and the fluid in fluid inlet 113 is small enough for inlet valve 113a to actuate to its closed position. As piston 115 begins to move longitudinally towards cylinder 112, the pressure on the fluid inside of cylinder chamber 117 begins to increase. Fluid pressure inside cylinder chamber 117 continues to increase as piston 115 approaches cylinder 112 until the differential pressure across outlet valve 114a is large enough to actuate valve 14a and allow the fluid to exit cylinder 112 through fluid outlet 114. In embodiments, fluid is only pumped across one side of piston 115, therefore reciprocating pump 10 is a single-acting reciprocating pump. If fluid were also being pumped on the side of piston 115 that connects to piston rod 116, this would be a double acting pump.

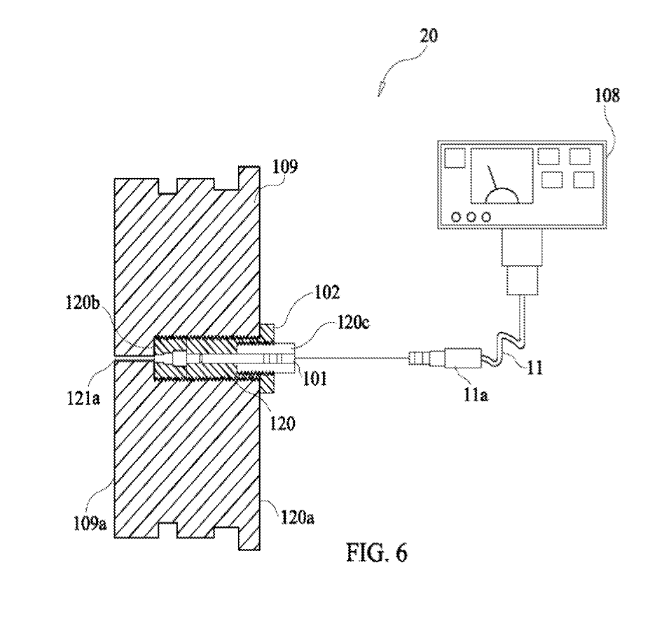

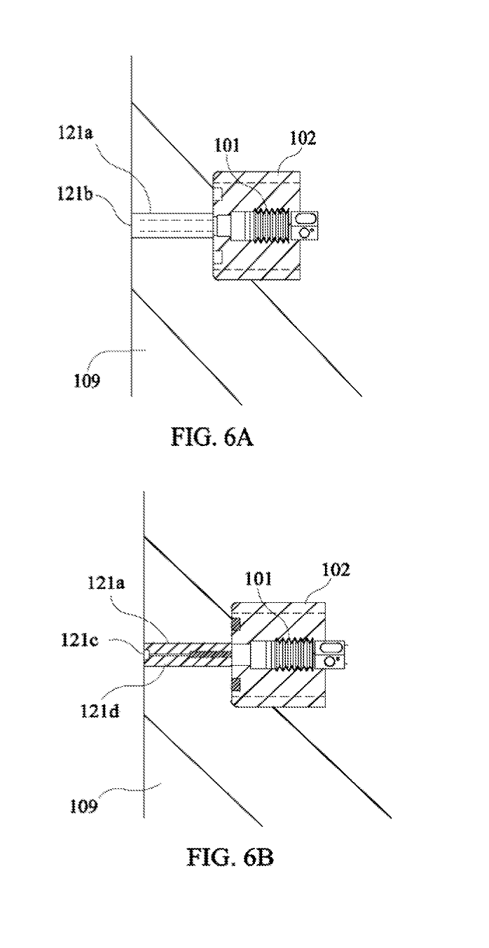

In some embodiments, a pressure sensor assembly monitors the pressure of fluid being pumped by reciprocating pump 10. As disclosed herein, there may be a plurality of pressure sensor assemblies advantageously positioned adjacent to various sidewalls of pump 10 to sense fluid pressure values at various locations throughout pump 10. For example, as shown in FIGS. 5 and 6, a pressure sensor assembly 20 mounted to cover plate 109, which allows for sensing the dynamic fluid pressure individually within each cylinder 112.

In some embodiments, wire 11 is in electrical communication with pressure sensor 101 through connector 11a. In some embodiments, each pressure sensor assembly 20 may include a plurality of wires 11 extending therefrom via a plurality of connectors 11a. In one aspect, wires 1 extending from each pressure sensor assembly 20 may be combined to form a single bundle or wire harness (not shown), which wire harness may allow an operator to selectively disengage wire harness while replacing or repairing cylinders 112. In some embodiments, the sensor may be a wireless sensor with the capability to communicate with a computer or other devices without a wiring harness.

In some embodiments, the pump 10 may include a monitoring housing or data collector 108. The monitoring housing or data collector 108 may be fixed to pump 10 or may be a detachable unit. Data collector 108 may comprise computer 108a (FIG. 4) that receives and stores data about the operating conditions of pump 10. In a manner known in the art, computer 108a includes memory. As shown in FIG. 4, computer 108a may include port 108b for downloading data from the memory to another computer. Additionally, computer 108a may optionally include portable memory that is removable and insertable through drive 108c. Such replaceable memory allows an operator to store operating conditions on the memory of computer 108a for a predetermined length of time, and then retrieve the memory with the stored data for analysis and replace the previous memory with a replacement memory for storing data for another predetermined length of time. Alternatively, the computer may communicate with other computers wirelessly, transmitting data to mobile devices (e.g., phones) offsite or to trailers onsite.

Data collector 108 receives and records the dynamic pressure for each of cylinders 112 associated with reciprocating pump 10 as pistons 115 stroke. As will be appreciated by those skilled in the art, the dynamic pressures from each cylinder 112 can then be transmitted from data collector 108 to a centrally located facility, a mobile device, or the measurements can be digitally stored until retrieved by an operator. Monitoring dynamic pressures within cylinder chambers 117 allows operators to monitor the efficiency of reciprocating pump 10. By monitoring dynamic pressures within cylinder chamber 117, operators may more effectively determine the appropriate time for replacing parts as well as determine the efficacy of operation of pump 10. In some cases, the data collector 108 or computer 108a analyzing the sensor data of the dynamic pressures within cylinder chamber 117 may determine that the pump 10 should be shut down, or pump 10 perform at a reduce pressure to prevent damage or for safety reasons, for example, if cavitation is present within cylinder chamber 117.

The shut down may be done either manually by the operator or automatically by the monitoring system (i.e., data collector 108 and/or computer 108a). If the shutdown or reduced pressure pumping is automatically done as part of the system, special computer program parameters or algorithms may be included within the system.

FIGS. 5 and 6 show examples of the embodiments of pressure sensor assembly 20. In the example shown in FIG. 5, pressure sensor assembly 20 is connected to one of cover plates 109 to sense dynamic pressure. In this embodiment, bolt 102 is partially contained within covers 118,119 separate from cover-plate 109, and sensor 101 is stabilized in cylinder 112 therethrough. In FIG. 6, bolt 102 is exposed to the exterior surface of pump 10 through the upper surface of cylinder 112 (not shown), where the lower surface of the bolt 102 head is flush against outer exposed shoulder 120 of cover-plate 109. Sensor 101 is stabilized by threaded cap 120c, which threaded cap 120c interdigitates with threads within the top of the cavity in bolt 102 (See FIGS. 1-3). In embodiments, the pressure sensor assembly 20 senses dynamic pressure through a recess 121a in the cover plate 109, which recess 121a affords movement of fluid therein. In different embodiments, the sensor may or may not be exposed to the fluid. For example, in one embodiment, the cover plate 109 includes a recess 121a so that the pressure sensor assembly 20 senses the dynamic pressure directly from the fluid (FIG. 4). In another embodiment (see FIGS. 6a and 6b), the cover plate 109 may have a membrane or separate diaphragm 121b with a fluid behind it e or moving portion 121c (surrounded by a compressible support material 121d) that transfers the dynamic pressure across the membrane/separate diaphragm or moving portion of the cover plate 109 without the pressure sensor assembly 20 being exposed to the fluid in chamber 117. In a related aspect, compressible support material 121d is elastic.

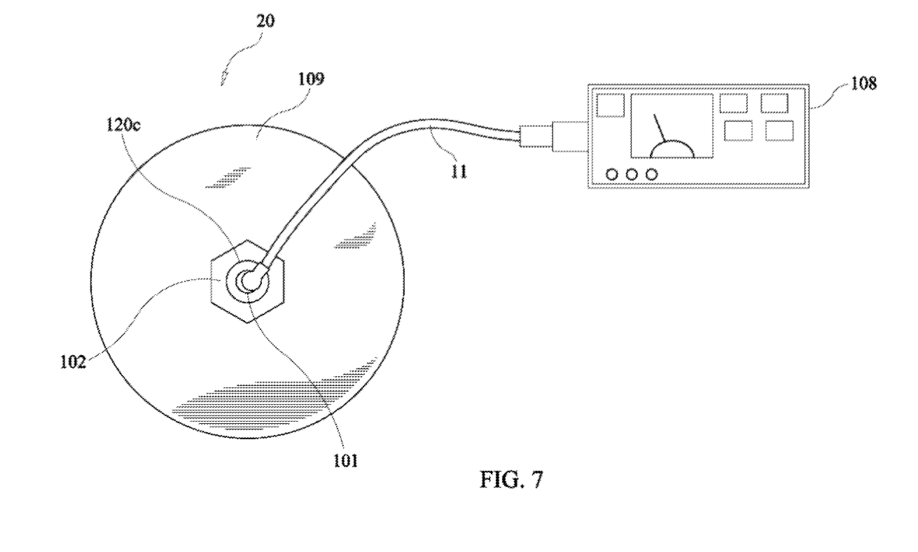

Referring to FIG. 7, pressure sensor assembly 20 may be positioned with the top of bolt 102 on the outer surface of cover plate 109. Referring to FIGS. 5 and 6, each cover plate includes threaded counter-bore 120, defining outward facing shoulder 120a. The sensor assembly is in electrical communication with memory 108a to sense a pressure value of a fluid within pump 10. The threaded plug member 102 extends partially through cover plate 109, plug member 102 having a cavity therethrough (see FIGS. 1-3), which plug member 102 registers with cover plate 109 within the counter-bore 120, where sensor 101 is flush mounted at the diaphragm end (see FIGS. 1-3) to be outward facing at the end of plug member 102 cavity via interdigitation of threads on sensor 101 and threads within a portion of the bottom of the cavity in bolt 102 and tightening of sensor 101 to the bottom of the cavity of bolt 102 by floating clamp nut 101a against a ledge within the cavity of bolt 102 (see FIGS. 1-3). The outward facing shoulder of plug member 102 is flush mounted to the inward facing end of counter-bore 120, where a recess 121a is formed between inward facing end 120b of counter-bore 120 and outward facing end 109a of the shoulder of cover plate 109, which cover plate shoulder 109a is proximal to piston chamber 117. As mentioned above, the cover plate 109, at 109b, may have a membrane/separate diaphragm 121b or a membrane/separate diaphragm 121b and a moving portion 121c that transfers the dynamic pressure to the sensor 101, thereby isolating sensor 101 from fluid in chamber 117.

In operation, pressure assemblies 20 are fixedly positioned adjacent to the chamber 117 above piston 115, however, it will be apparent to one of skill in the art that other positions along the side wall may be used.

Computer 108a stores the sensed values from pressure sensor assemblies 20 in the computer memory. The operator may download the sensed values from the memory via port 108b. In embodiments, the operator may alternatively remove the memory with the stored values from computer 108a via drive 108c, and insert a replacement memory for receiving and storing continued sensed operating conditions. This allows continuous monitoring of sensed pressure values of fluid, and at high pressures within reciprocating pump 10 during long periods of operation, rather than only during short test runs.

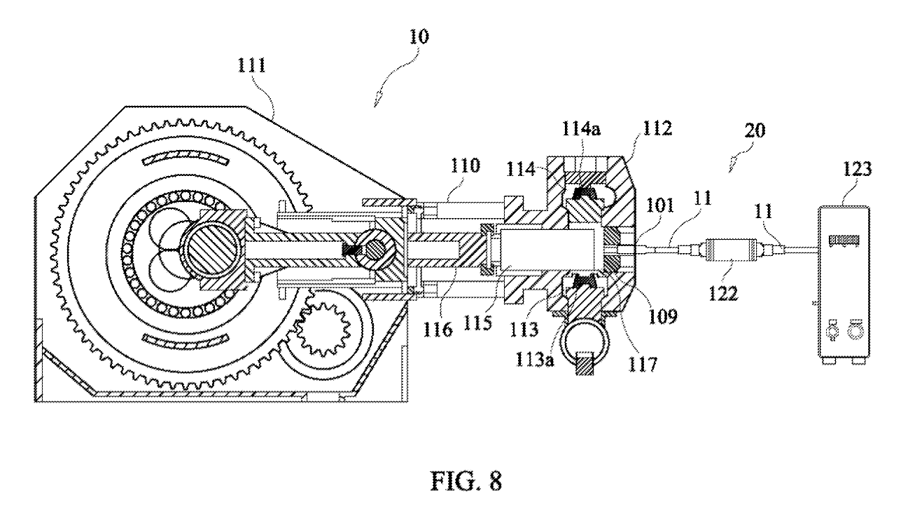

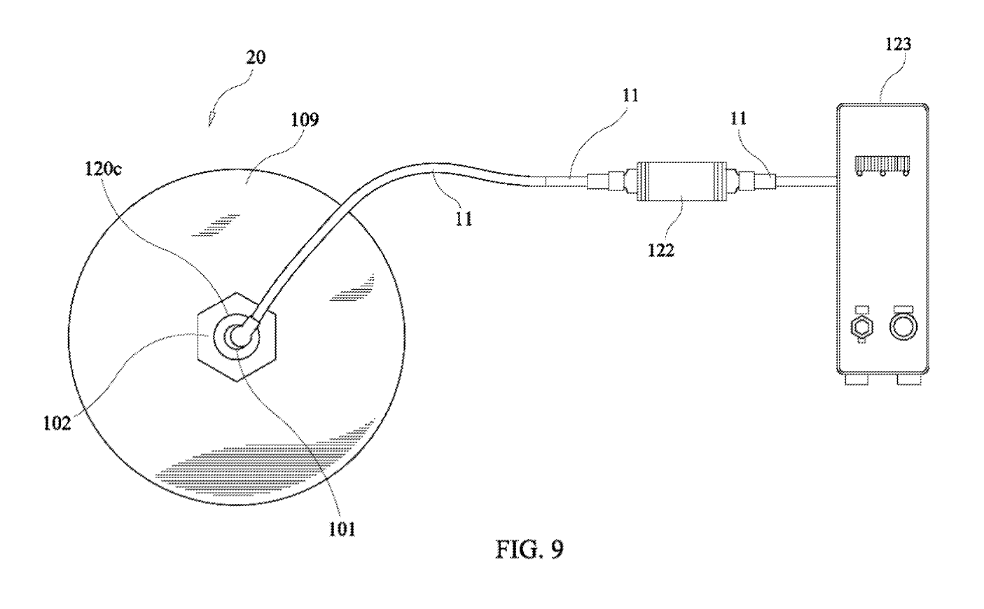

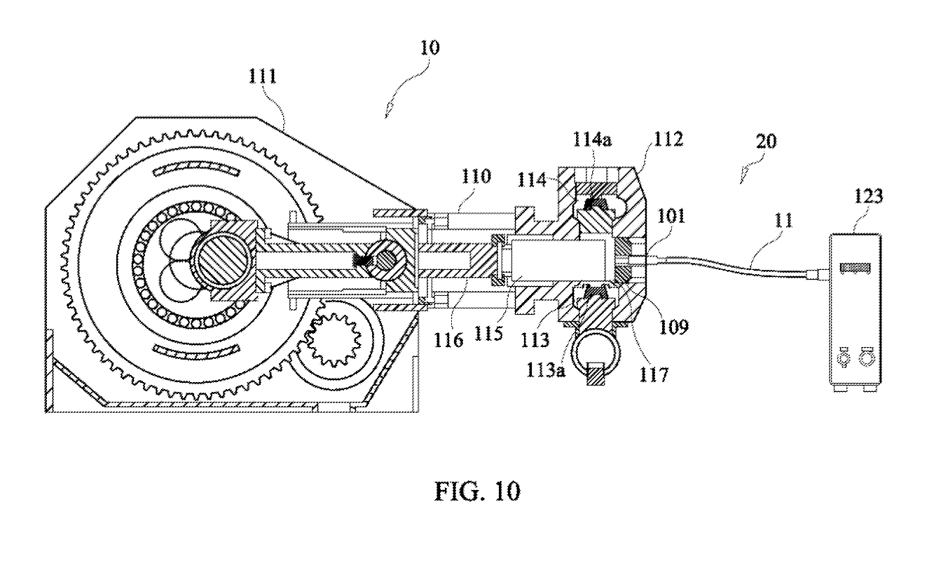

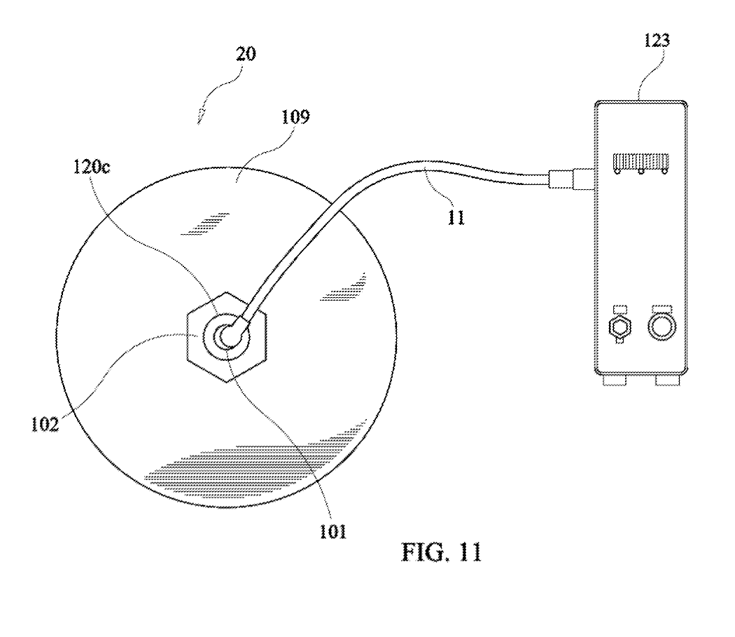

In FIGS. 8 and 9, sensor assembly 20 includes in-line charge amplifier 122 connected to current source power unit 123 before being connected to monitor 108 (not shown). In FIGS. 10 and 11, sensor assembly 20 includes current source power unit 123 before being connect to monitor 108 (not shown).

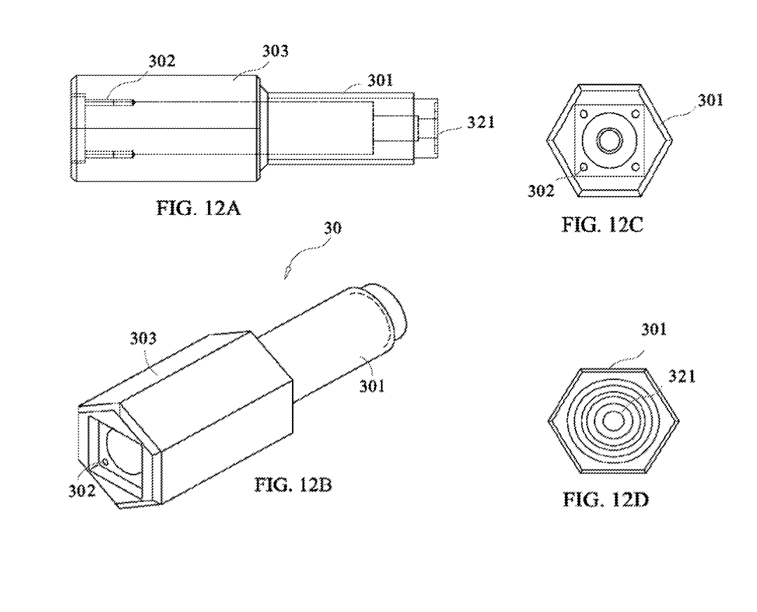

Referring to FIGS. 12A-12D, an alternate bolt configuration 30 is shown. In this configuration 30 the bolt 301 contains tapped holes 302 in the bolt head 303, which holes 302 function to secure connector 11a (not shown, refer to FIG. 5). Note that the bolt head 303 is longer compared to the bolt head of bolt 102 (refer to FIG. 1).

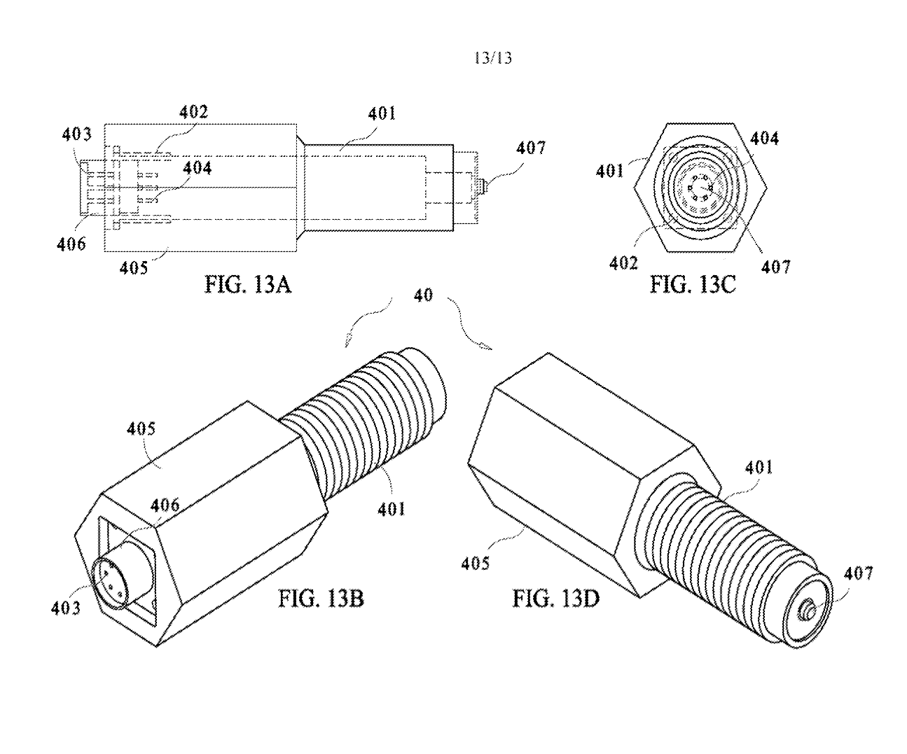

Referring to FIGS. 13A-13D, a separate alternate bolt configuration 40 is shown. In this configuration 40 the bolt 401 contains tapped holes 402, recesses 403 and electric leads 404 in the bolt head 405. In addition, the bolt head 405 comprises a removable projection 406, which allows for facile insertion of the sensor 101 into the bolt 401. Again, holes 402 function to secure connector 11a (not shown, refer to FIG. 5), where projection 406 in combination with electric leads 404 allow for more secure and effective engagement between the sensor 101 and, for example, instrumentation and power supply. Note again that the bolt head 405 is longer compared to the bolt head of bolt 102 (refer to FIG. 1). In embodiments, the bolt 401 may comprise a second projection 407, which second projection 407 may serve as a coupling mechanism that allows for mechanical transfer of motions/forces outside of the bolt 401 to the diaphragm 101c.

While the invention has been shown in only some of its forms, it should be apparent to those skilled in the art that it is not so limited, but is susceptible to various changes without departing from the scope of the invention. For example, while all the figures illustrate service pumps that are typically used for cementing, acidizing, or fracking, the monitoring assembly 20 could also easily be used on mud pumps for drilling operations.

We claim herein:

1. A reciprocating pump comprising:
a pump housing that houses a crankshaft;
a piston mechanically connected to the crankshaft for pumping a fluid through a cylinder, wherein the cylinder comprises a fluid inlet and a fluid outlet;
a monitor;
a computer in transmission communication with the monitor, wherein the computer comprises a memory; and
a ballistic pressure sensor mounted to the pump,
wherein said ballistic sensor is in electrical communication with the monitor to sense a pressure value of a fluid within the pump.

2. The pump assembly according to claim 1, wherein the ballistic sensor is configured to engage within a cavity of a bolt, wherein the bolt partially extends into a portion of a cover plate mounted to the reciprocating pump, and wherein the bottom of said bolt is positioned adjacent to a chamber above the piston.

3. The pump assembly according to claim 2, wherein the bolt comprises a non-conductive metal.

4. The pump assembly according to claim 3, wherein the bolt comprises anodized aluminum.

5. The pump assembly according to claim 2, wherein the ballistic sensor engages within the cavity of the bolt such that the diaphragm end of said ballistic sensor containing the sensing electronics is flush mounted to the bottom surface of the bolt or is flush fitted to a bore hole at the bottom of the bolt.

6. A reciprocating pump assembly comprising;
a pump housing that houses a crankshaft;
a plurality of pistons mechanically connected to the crankshaft for pumping a fluid through a plurality of cylinders, wherein the plurality cylinders comprise a fluid inlet and a fluid outlet, and wherein each of the piston rods comprise a piston portion on the end extending away from the crankshaft;
a plurality of piston chambers in fluid communication with the piston portion of each of the piston rods, wherein each of the piston chambers receives fluid to be pumped by the piston portion of each of the piston rods, and wherein each of the piston chambers comprise a fluid inlet and a fluid outlet;
a plurality of cover plates extending through a selected plurality of sidewalls of the reciprocating pump, wherein each of the cover plates comprise a threaded counter-bore, defining an outward facing shoulder;
a monitor,
a computer in transmission communication with the monitor, wherein the computer comprises a memory; and
a plurality of ballistic pressure sensors mounted to the cover plates,
wherein the plurality of ballistic sensors are in electrical communication with the monitor to sense a pressure value of a fluid within the pump.

7. The pump assembly according to claim 6, further comprising a threaded bolt extending partially through each of the cover plates, the bolt having a cavity therethrough, which bolt registers with the cover plates within the counter-bore, wherein each of the ballistic sensors is flush mounted at the diaphragm end at an inward facing end of the bolt cavity or the diaphragm is flush fitted through a borehole in the bottom of the bolt, wherein the outward facing shoulder of the bolt is flush mounted to the inward facing end of the counter-bore, and wherein a delimited gap is formed between the outward facing end of the counter-bore and the outward facing end of the shoulder of the cover plate, which cover plate shoulder is proximal to the piston chamber, wherein said gap optionally comprises a membrane or separate diaphragm behind which a fluid or a mechanical means communicates dynamic pressure through said cover plate to said sensor, thereby isolating the sensor from the fluid or the sensor is in direct contact with the fluid.

8. The pump assembly according to claim 6, wherein the bolt comprises a non-conductive metal.

9. The pump assembly according to claim 6, wherein the bolt comprises anodized aluminum.

10. The pump assembly according to claim 6, further comprising a memory housing, wherein the memory is a portable module that is adapted to be removed to have information retrieved from the memory at another location and replaced with another portable module to receive data from the sensors.

11. A method of monitoring the operating conditions of a reciprocating pump assembly of claim 1 comprising:
providing a computer with a memory, mounting the computer in a monitoring housing, and mounting the monitoring housing to the reciprocating pump;
positioning a plurality of pressure sensor assemblies in impulse communication with ports formed in a selected location and electrically connecting the sensor assemblies to the computer of the reciprocating pump;
operating the pump;
sensing fluid pressure with the sensor assemblies; and
communicating pressure values from each of the sensor assemblies to the memory.

12. A sensor assembly for sensing fluid pressure within a reciprocating pump cylinder comprising:
a ballistic pressure sensor or transducer capable of measuring pressure within the cylinder,
a bolt having a throughbore configured to hold the sensor, and
a cover plate proximate to the cylinder configured to hold the bolt and sensor in a select position relative to the cylinder,
wherein the ballistic pressure sensor or transducer is configured to generate an electric signal which is proportional to a pressure value within the cylinder of the pump.

13. The sensor assembly according to claim 12, further comprising a computer system configured to receive the electrical signal from ballistic pressure sensor or transducer and compute the dynamic pressure changes within the cylinder.

14. The sensor assembly according to claim 12, wherein the ballistic pressure sensor or transducer communicates wirelessly with the computer system.

15. The sensor assembly according to claim 12, wherein the computer system is configured to alter the reciprocating pump operation if the dynamic pressure changes within the cylinder are not within accepted parameters.

16. The sensor assembly of claim 12, wherein the head of the bolt comprises one or more tapped holes and a first projection at the one end of the bolt, a second projection at another end of the bolt, or a combination thereof.

17. The sensor assembly of claim 16, wherein the first projection comprises one or more recesses for engaging one or more prongs of a coaxial connector.

18. The sensor assembly of claim 16, wherein the first projection further comprises one or more electrical leads which are in communication with said one or more recesses.

19. The sensor assembly of claim 12, wherein said bolt comprises one or more tapped holes, a first projection on the top end of the bolt, and a second projection at the bottom end of the bolt.

20. The sensor assembly of claim 12, wherein said second projection is configured to mechanically transfer motions outside of the bolt to a diaphragm on the ballistic pressure sensor or transducer.
